(19) United States
(12) Patent Application Publication
(10) Pub. No.: US 2013/0136057 A1
(43) Pub. Date: May 30, 2013

(54) Base Station Aided Synchronization

(71) Applicants: Peter Skov, Beijing (CN); Agnieszka Szufarska, Gdansk (PL); Jie Zhen Lin, Beijing (CN); Chun Hai Yao, Beijing (CN); Dong Zhao, Beijing (CN)

(72) Inventors: Peter Skov, Beijing (CN); Agnieszka Szufarska, Gdansk (PL); Jie Zhen Lin, Beijing (CN); Chun Hai Yao, Beijing (CN); Dong Zhao, Beijing (CN)

(21) Appl. No.: 13/579,062

(22) PCT Filed: Feb. 15, 2010
(86) PCT No.: PCT/CN10/00211

§ 371 Date: Feb. 7, 2013

(51) Int. Cl. H04W 56/00

(52) U.S. Cl. CPC H04W 56/001
USPC 370/328

(57) ABSTRACT

An apparatus, method and computer program product include requesting a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance. Prior to the requesting, an initial synchronization with a neighbor base station can be established. After the requesting, an accurate synchronization with the overly base station based on the obtained physical identifier can be established.

### FIELD OF THE INVENTION

The present invention relates to an apparatus, method, system and computer program product for base station aided synchronization. In particular, the present invention relates to an apparatus, method, system and computer program product for aiding synchronization of a home evolved Node B to an evolved Node B of a macro cell or a home evolved Node B.

### RELATED BACKGROUND ART

Prior art which is related to this technical field can e.g. be found by the technical specifications TS 25.820 current version: 8.2.0), TS 36.300 (current version 9.2.0), TS 36.413 (current version 9.1.0), and TS 36.423 (current version: 9.1.0) of the 3GPP.

The following meanings for the abbreviations used in this specification apply:

3GPP: 3^{rd} Generation Partnership Project

CRS: Common Reference Signal

CSG: Closed Subscriber Group

DL: Downlink

DwPTS: Downlink Pilot Time Slot

eNB: evolved Node B (eNode B)

GP: Guard Period

GPS: Global Positioning System

GNSS: Global Navigation Satellite System

HeNB: Home eNB

ID: Identifier

IE: Information Element

LTE: Long Term Evolution

LTE-A: Long Term Evolution Advanced

OFDMA: Orthogonal Frequency Division Multiple Access

OSG: Open Subscriber Group

PBCH: Physical Broadcast Channel

PC: Power Control

PCI: Physical Cell Identifier

PSS: Primary Synchronization Channel

SC-FDMA: Single Carrier Frequency Division Multiple Access

SIB: System Information Block

SINR: Signal to Interference and Noise Ratio

SON: Self Organizing Network

SSF: Special Sub-frame for TDD

SSS: Secondary Synchronization Channel

TDD: Time Division Duplex

UE: User Equipment

In recent years, 3GPP's LTE as the upcoming standard is under particular research. The base station of LTE is called eNodeB. LTE will be based on OFDMA in downlink and SC-FDMA in uplink. Both schemes allow the division of the uplink and downlink radio resources in frequency and time, i.e. specific frequency resources will be allocated for certain time duration to the different UE. The access to the uplink and downlink radio resources is controlled by the eNode B that controls the allocation of the frequency resources for certain time slots.

Furthermore, for mobile wireless communication systems such as those according to the 3GPP LTE low transmission power eNBs (which in the following are called Home eNodeB, but not preclude other types of low power eNB for indoor deployment, such as pico, micro, and relay eNBs, etc) are proposed, mainly for use indoors. These nodes can be operated at the same frequency layer, i.e. the same carrier frequency in the same frequency band, as a wide area eNB.

As LTE supports TDD, a synchronization of the Home eNodeB (HeNB) to the wide area eNB is needed. Thus, it is currently under discussion in 3GPP to synchronize between eNBs and especially HeNBs in TDD mode to avoid co-channel interference introduced by asynchronous operation. Since a HeNB may not have a GNSS (e.g. GPS) receiver integrated (due to cost-related issues), and since the GNSS signal is anyway quite weak indoors, additional synchronization schemes other than a GNSS-based solution are needed.

In this regard, network listening is a baseline scheme for TDD HeNB synchronization. In the current discussions of 3GPP, network listening is considered an essential synchronization technique for HeNB, which is assuming that HeNB will follow the PSS/SSS of the source cell (i.e. of the wide area eNB) at booting stage and get synchronization. In addition, the HeNB may also maintain the synchronization by periodically monitoring the CRS of the source cell and adjust its own transmit time and/or frequency reference according to that received waveform. For the CRS tracking, the HeNB will adopt a common slot to hear the CRS of the source cell in order to avoid interference from its neighbor HeNB cells.

One-hop is the typical scenario for LTE/LTE-A. The general scenario is the one-hop synchronization that enables HeNB synchronization with macro eNBs (i.e. with the source cell) where the macro layer signal can be received well.

For CRS tracking there is a common time slot defined in which the HeNB will consecutively mute. This avoids mutual interference and the CRS SINR can generally be received by HeNB above −5 dB, which is good enough.

In the PSS/SSS monitoring at the booting stage, the interference from other neighbor HeNB can not be avoided with this scheme, since it is difficult for HeNB to mute this PSS/SSS singling which is essential for UE attachment. Generally, to successfully search a macro layer cell, the PSS/SSS SINR at the HeNB needs to be above −10 dB. If interference is not avoided, then the possibility that the PSS/SSS SINR is lower than −10 dB may be significant, especially in cases when no power control scheme is adopted and all HeNB transmit with maximum DL power. Reference is made to FIG. 1 showing the SINR at a HeNB with respect to an overlay macro cell with other HeNB also transmitting.

In such case the bottleneck impacting the TDD HeNB synchronization feasibility to the macro cell is PSS/SSS SINR rather than CRS SINR. That is, for PSS/SSS detecting a newly booted HeNB needs to get synchronization with the macro cell and also needs to get the PCI of the macro cell eNB for further CRS detection and synchronization maintenance.

### SUMMARY OF THE INVENTION

It is an object of the present invention to overcome at least some of the drawbacks of the prior art.

According to a first aspect of the present invention, this is accomplished by an apparatus, comprising identifier obtaining means configured to request a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

Modifications of the first aspect may be as follows.

The apparatus according to the first aspect may be configured to be suitable for base station aided synchronization.

Further, the apparatus can further comprise synchronization means configured to trace a common reference signal of the communication base station having the preset hierarchical distance and to synchronize a communication configuration with any communication base station.

The apparatus can further comprise selection means configured to select a second communication base station having a higher hierarchical distance than the preset hierarchical distance and based on a signal strength at a signal receiving position, while ignoring the first communication base station, if the physical identifier of the communication base station having the preset hierarchical distance or the common reference signal of the communication base station having the preset hierarchical distance is not available.

The selection means can be further configured to trigger the synchronization means to merely synchronize a communication configuration with the first or second communication base station, if tracing the common reference signal of the communication base station having the preset hierarchical distance fails.

The apparatus can further comprise decoding means configured to decode a physical broadcast channel transmitted by the first or second communication base station having a higher hierarchical distance than the preset hierarchical distance and to retrieve a global identifier of this communication base station.

The apparatus can further comprise control means configured to initiate a physical identifier detection procedure related to communication base stations, to decide on the hierarchical distance of a communication base station of which a physical identifier is detected, to trigger operation of the identifier obtaining means in dependency of a decision result, and to trigger operation of the synchronization means and the selection means.

According to a second aspect of the present invention, the object is accomplished by an apparatus, comprising an identification processor configured to request obtaining a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

Modifications of the second aspect of the present invention may correspond to the modifications of the first aspect.

According to a third aspect of the present invention, the object is accomplished by a method, comprising requesting a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

Modifications of the third aspect may be as follows.

The method according to the third aspect may be configured to be suitable for base station aided synchronization.

The method can further comprise tracing a common reference signal of the communication base station having the preset hierarchical distance; and synchronizing a communication configuration with the communication base station having the preset hierarchical distance.

The method can further comprise detecting that the physical identifier of the communication base station having the preset hierarchical distance or the common reference signal of the communication base station having the preset hierarchical distance is not available; and selecting a second communication base station having a higher hierarchical distance than the preset hierarchical distance and based on a signal strength at a signal receiving position, while ignoring the first communication base station.

The method can further comprise detecting that tracing a common reference signal of the communication base station having the preset hierarchical distance fails; and synchronizing a communication configuration with the first or second communication base station.

The method can further comprise decoding a physical broadcast channel transmitted by the first or second communication base station having a higher hierarchical distance than the preset hierarchical distance; and retrieving a global identifier of this communication base station.

The method can further comprise initiating a physical identifier detection procedure related to communication base stations; and deciding on the hierarchical distance of a communication base station of which a physical identifier is detected, wherein the initiating and deciding is performed prior to the requesting.

The method according to the third aspect or any of its modifications may be performed by the apparatus according to the first or second aspect or suitable ones of their modifications.

According to a fourth aspect of the present invention, the object is accomplished by an evolved Node B, comprising an apparatus according to the first or second aspect of the present invention or any one of their modifications.

According to a fifth aspect of the present invention, the object is accomplished by a computer program product comprising computer-executable components which perform, when the program is run on a computer requesting a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

Modifications of the fifth aspect may be as follows.

The computer program product according to the fifth seventh aspect may be suitable for base station aided synchronization.

The computer program product according to the fifth aspect may be embodied as a computer-readable storage medium.

Otherwise, modifications of the fifth aspect may correspond to the modifications of the third aspect.

It is to be understood that any of the above modifications can be applied singly or in combination to the respective aspects to which they refer, unless they are explicitly stated as excluding alternatives.

### BRIEF DESCRIPTION OF THE DRAWINGS

The above and other objects, features, details and advantages will become more fully apparent from the following detailed description of the preferred embodiments which is to be taken in conjunction with the appended drawings, in which:

FIG. 1 shows a SINR at a HeNB with respect to a best overlay macro cell with other HeNB also transmitting;

FIG. 2 shows a SINR at a HeNB with respect to a best cell (both overlay macro cell and any other HeNB);

FIG. 3 shows an apparatus according to certain embodiments of the present invention; and

FIG. 4 shows a flow chart illustrating a method according to certain embodiments of the present invention.

### DETAILED DESCRIPTION OF THE PREFERRED EMBODIMENTS

In the following, description is made to what are presently considered to be preferred embodiments of the present invention. It is to be understood, however, that the description is given by way of example only, and that the described embodiments are by no means to be understood as limiting the present invention thereto.

For example, for illustration purposes, in some of the following exemplary embodiments, base station aided synchronization to a base station of lower hierarchical distance to a communication core network such as e.g. based on LTE-Advanced is described. However, it should be appreciated that these exemplary embodiments are not limited for use among these particular types of wireless communication systems, and according to further exemplary embodiments, the present invention can be applied also to other types of communication systems and access networks in which the problem of synchronization due to an partially undetected synchronization source base station occurs.

Thus, certain embodiments of the present invention relate to mobile wireless communication systems, such as 3GPP LTE and 3GPP LTE-Advanced. In more detail, certain embodiments of the present invention are related to the configuration of an LTE eNB/HeNB and components thereof, or the like.

However, as indicated above, the present invention is not limited to eNB/HeNB, but other embodiments of the present invention are related to base station nodes and components thereof.

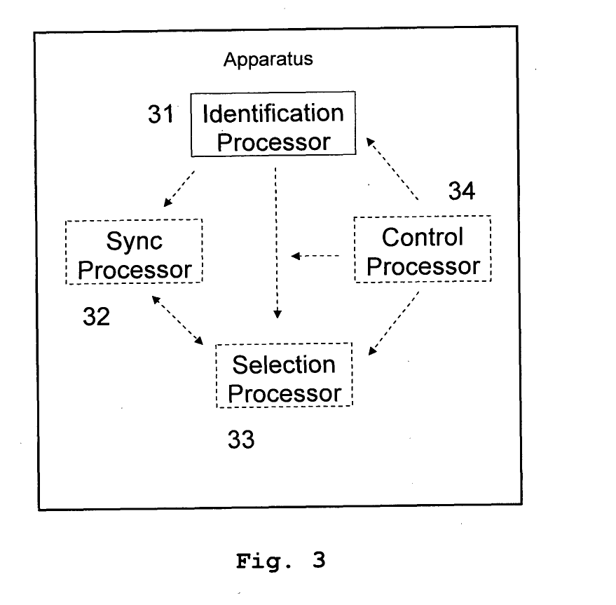

FIG. 3 shows a principle configuration of an example for an apparatus according to certain embodiments of the present invention. One option for implementing this example for an apparatus according to certain embodiments of the present invention would be a component in a Home evolved Node B according to LTE.

Specifically, as shown in FIG. 3, the example for an apparatus comprises an identification processor 31 configured to request obtaining a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

In optional modifications, as also shown in FIG. 3, the apparatus may comprise one or more of a synchronization processor 32 configured to trace a common reference signal of the communication base station having the preset hierarchical distance and to synchronize a communication configuration with any communication base station, a selection processor 33 configured to select a second communication base station having a higher hierarchical distance than the preset hierarchical distance and based on a signal strength at a signal receiving position, while ignoring the first communication base station, if the physical identifier of the communication base station having the preset hierarchical distance or the common reference signal of the communication base station having the preset hierarchical distance is not available, wherein the selection processor 33 can be further configured to trigger the synchronization processor 32 to merely synchronize a communication configuration with the first or second communication base station, if tracing the common reference signal of the communication base station having the preset hierarchical distance fails, and a control processor 34 configured to initiate a physical identifier detection procedure related to communication base stations, to decide on the hierarchical distance of a communication base station of which a physical identifier is detected, to trigger operation of the identification processor 31 in dependency of a decision result, and to trigger operation of the synchronization processor 32 and the selection processor 33.

According to certain embodiments of the present invention, a base station may, depending on circumstances, refer to any kind of evolved Node B, while a macro cell evolved Node B is assumed to have a closer hierarchical distance to a core network than a home evolved Node B, wherein the hierarchical distance can particularly be well defined within its network environment so as to be “preset”. Accordingly, a base station having a higher hierarchical distance than such base station having the preset hierarchical distance (i.e. the eNB) may refer to a HeNB, as may e.g. be the case with the above referred to first and second communication base station. Further, according to the example of applying the present invention to LTE-A, an implementation example for the interface between a communication base station having a higher hierarchical distance than the preset hierarchical distance and the communication core network would be the S1 interface as defined by 3GPP, while an implementation example for the interface between two communication base stations both having a higher hierarchical distance than the preset hierarchical distance would be the X2 interface as defined by 3GPP.

Further modifications will become more fully apparent from the below detailed description of further certain embodiments of the present invention.

It should be understood that the depiction is for illustration purposes and serves as an example. However, each of the depicted elements may stand for one or more implementation elements, or two or more of the depicted elements may be implemented in one element.

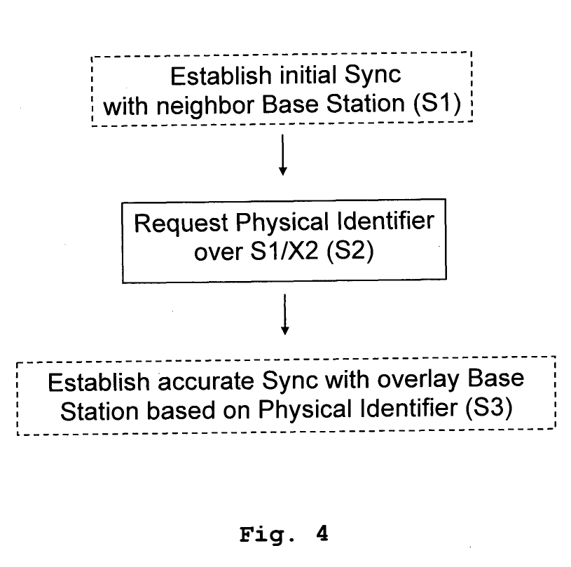

FIG. 4 shows a principle flowchart of an example for a method according to certain embodiments of the present invention. That is, as shown in FIG. 4, this method comprises requesting S2 a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

According to certain modifications, and as will be described herein below in further detail, this step may be preceded by establishing S1 an initial synchronization with a neighbor base station. This may involve one or more of the following. That is, the method can further comprise initiating a physical identifier detection procedure related to communication base stations; and deciding on the hierarchical distance of a communication base station, of which a physical identifier is detected. Where neither of the detected physical identifier corresponds to a base station having the preset hierarchical distance, a communication configuration is (initially) synchronized with a base station having a higher hierarchical distance than the preset hierarchical distance such as the above mentioned first or second communication base station.

According to further certain modifications, the requesting may be succeeded by establishing S3 an accurate synchronization with the overlay base station based on the physical identifier obtained by the requesting. This may involve the following. That is, the method can further comprise tracing a common reference signal of the communication base station having the preset hierarchical distance; and synchronizing a communication configuration with the communication base station having the preset hierarchical distance.

Further modifications will become more fully apparent from the below detailed description of further certain embodiments of the present invention.

One option for performing the example of a method according to certain embodiments of the present invention would be to use the apparatus as described above or a modification thereof which becomes apparent from the embodiments as described herein below.

In general, according to certain embodiments of the present invention, a primary synchronization with a macro cell is provided and the Physical Cell ID (e.g. PCI) of the macro cell is obtained without detecting the macro cell's synchronization signals (e.g. PSS/SSS).

Specifically, when a HeNB is not able to synchronize with the macro cell, the HeNB considers fully synchronizing with its neighbour HeNB (including booting up synchronization and synchronization maintenance).

According to certain embodiments of the present invention, this involves to get approximate primary synchronization with the macro cell without detecting the macro cell's PSS/SSS, to get the macro cell's PCI without detecting the macro cell's PSS/SSS, and in general to decide when to use this method and when to follow a general macro cell PSS/SSS detection procedure.

This is described in further detail below.

According to certain embodiments of the present invention, if a HeNB finds that all successfully detected PCI belong to other HeNB, such newly booted HeNB can follow a strongest signal out of its neighbor HeNBs (so-called aid source HeNB) and get an initial synchronization with it. This is carried out under a one-hop assumption for the network, i.e. the neighbor is assumed to be synchronized with the macro cell. Then the newly booted HeNB has also approximately synchronized with the macro cell.

Further, according to certain embodiments of the present invention, the HeNB sends a request message in order to obtain the PCI of the macro cell. Such request should be directed to a network element in possession of this information such as a network element of the core network or another (neighbor) eNB/HeNB. Accordingly, considering the LTE/LTE-A case, for example the S1 or X2 interface can be used to direct this message e.g. to the aid source HeNB of the newly booted HeNB for the PCI of the macro cell.

In response to such request, the PCI of the macro cell can be received via a response S1 or X2 message, e.g. from the aid source HeNB.

If it is necessary that, for example, the global cell ID of the aid source HeNB is needed for the S1 or X2 request message, according to certain embodiments of the present invention, the newly booted HeNB can obtain that by decoding the PBCH of the aid source HeNB.

Accordingly, after booting a HeNB can carry out a cell search for PCI, and if all successfully detected PCI are of HeNBs, the HeNB conducts the above described scheme. Else the HeNB can follow a normal UE DL synchronization procedure to the macro cell.

According to certain embodiments of the present invention, one detection process to identify whether the decoded PCI belongs to Macro BS or HeNB may involve checking SSF configurations on SIB1 of PBCH for a GP based synchronization scheme, where all HeNBs will have a same longer GP configuration than the macro cell, and another detection process may involve decoding for PCI from PSS/SSS signals, or a CSG indicator and a CSG identity in SIB1.

Finally, after getting the approximate initial synchronization with the macro cell and obtaining the macro cell PCI, the HeNB is able to trace the CRS of the macro cell on its own defined time slot in order to adjust/maintain its synchronization accurately to the macro cell. Afterwards, this HeNB can rely on its own measurements.

Furthermore, according to certain embodiments of the present invention, if based on such initial synchronization and obtained macro cell PCI, the HeNB can not correctly detect the CRS for several tracing opportunities, or the feedback results for the queried PCI is “Null”, then the HeNB can retry the steps to follow a strong neighbor HeNB signal for initial synchronization and requesting the macro cell PCI from that HeNB, while ignoring the previous aid source HeNB.

Eventually, according to further certain embodiments of the present invention, if the procedure fails for all the decoded HeNBs, the newly booted HeNB can fully synchronize with a selected neighbor HeNB to result in normal multi-hop synchronization.

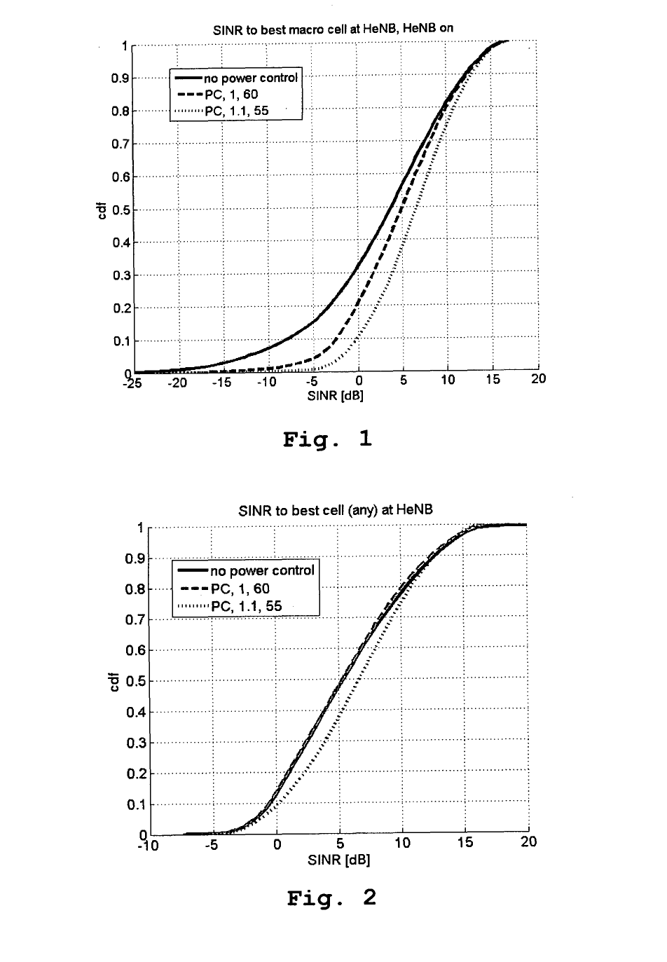

In FIG. 1 the SINR statistics of the prior art are shown that can be observed in dense urban scenarios by a booting HeNB.

If the new HeNB uses other HeNB as the primary approximate source of synchronization-related information instead of macro eNB, then the observed SINR statistics are significantly improved as shown in FIG. 2, showing the SINR at HeNB with respect to the best (received) cell (both overlay macro call and any other HeNB).

Although in comparison with FIG. 1, the SINR with power control (especially with a simple PC with parameters (alpha=1.1, beta=55 dB) where alpha is used for slope adjustment to cell range whereas beta is a pathloss offset) does not change much, this only means that with appropriate PC, the HeNB will always select the macro cell as its best cell and execute a single-hop synchronization. However, the solution according to the described embodiments still has considerable value in consideration of the fact that for example OSG and hybrid CSG type HeNBs also exist in networks. Though, HeNB of such type can not easily adopt PC, since they need to keep coverage and therefore need to apply maximum transmission power. Another case is of coursed if a PC scheme is not appropriately optimized.

The above described certain embodiments of the present invention are further detailed below by referring to implementation examples forming further certain embodiments of the present invention.

As an example, below is described a detailed procedure. The HeNB boots up and selects a neighbor HeNB, if it cannot detect the macro cell). Then, the newly booted HeNB follows the PSS/SSS of this HeNB under the assumption that this neighbor HeNB has already synchronized with the macro cell, and gets initial synchronization with the neighbor HeNB. Accordingly, the newly booted HeNB approximately gets initial synchronization with the macro cell. The HeNB can decode global cell ID of this neighbor HeNB as well. Further, the newly booted HeNB will also apply the common muting place for synchronization. In detail, under the premise of single hop synchronization scheme the muting place can be pre-configured by all HeNBs based on selected pairs (with a GP-based solution, a shortened DwPTS configuration is to be used. For example, if the macro cell uses a longer DwPTS configuration, the CRS in the late part of DwPTS can be monitored by HeNB, since at that time the HeNB is on GP and will not transmit to its attached UEs).

Then, via X2 or S1 interface signaling, the HeNB queries the neighbor HeNB for PCI of the macro cell as the synchronization source of the neighbor HeNB.

One concrete implementation example is based on S1 interface signaling (and by specifically referring to 3GPP TS 36.413), as follows:

A new IE “Synchronization Source Info” is defined (which is also added into the messages “SON Information Request” and “SON Information Reply” signaling with presence set to “optional”).

The “Synchronization Source Info” IE is used for signaling the synchronization source cell (especially the macro cell) CellIndex (PCI) by the neighbor HeNB to facilitate the over-the-air synchronization using network listening. The following definition is provided on the basis of 3GPP TS 36.413 with the empty columns “semantics description”, “criticality” and “assigned criticality” omitted for clarity purposes (note that M stands for “mandatory” for CellIndex if “Synchronization Source Info” IE be included in relevant messages.).

| IE/Group Name | | | |
|---|---|---|---|
| Synchronization | | | IE type and |
| Source Info | Presence | Range | reference |
| > CellIndex | M | (0 . . . | INTEGER |
| | | maxCellMeas) | (1 . . . maxCellMeas) |
| | | | for Cell Index |
| | | | Or INTEGER (0) |
| | | | for “Null” |

Another implementation example is based on X2 interface signaling (and by specifically referring to 3GPP TS 36.423), as follows:

A new IE “Synchronization Source Info” is defined (which is also added into the messages “RESOURCE STATUS REQUEST” and “RESOURCE STATUS RESPONSE” signaling with presence set to “optional”). Here, the following definition is provided on the basis of 3GPP TS 36.423 with the empty columns “semantics description”, “criticality” and “assigned criticality” omitted for clarity purposes (note that M stands for “mandatory” for CellIndex if “Synchronization Source Info” IE be included in relevant messages).

| IE/Group Name | | | |
|---|---|---|---|
| Synchronization | | | IE type and |
| Source Info | Presence | Range | reference |
| >CellIndex | M | (0 . . . | INTEGER |
| | | maxCellMeas) | (1 . . . maxCellMeas) |
| | | | for Cell Index |
| | | | Or INTEGER (0) |
| | | | for “Null” |

As indicated above, implementation examples for certain embodiments of the present invention include base station equipment capable of base station aided synchronization to a base station of higher hierarchical level such as LTE/LTE-Advanced eNB, but are not limited thereto.

According to the above description, it should thus be apparent that exemplary embodiments of the present invention provide, for example from the perspective of a network element such as an evolved Node B (eNB)/Home evolved Node B (HeNB) or a component thereof, an apparatus embodying the same, a method for controlling and/or operating the same, and computer program(s) controlling and/or operating the same as well as mediums carrying such computer program(s) and forming computer program product(s).

For example, described above are apparatuses, methods and computer program products capable of base station aided synchronization to a base station of higher hierarchical level.

Implementations of any of the above described blocks, apparatuses, systems, techniques or methods include, as non limiting examples, implementations as hardware, software, for example in connection with a digital signal processor, firmware, special purpose circuits or logic, general purpose hardware or controller or other computing devices, or some combination thereof.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1. An apparatus, comprising:
identifier obtaining means configured to request a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

2. The apparatus according to claim 1, further comprising: synchronization means configured to trace a common reference signal of the communication base station having the preset hierarchical distance and to synchronize a communication configuration with any communication base station.

3. The apparatus according to claim 1, further comprising:
selection means configured to select a second communication base station having a higher hierarchical distance than the preset hierarchical distance and based on a signal strength at a signal receiving position, while ignoring the first communication base station, if the physical identifier of the communication base station having the preset hierarchical distance or the common reference signal of the communication base station having the preset hierarchical distance is not available.

4. The apparatus according to claim 3, wherein the selection means is further configured to trigger the synchronization means to merely synchronize a communication configuration with the first or second communication base station, if tracing the common reference signal of the communication base station having the preset hierarchical distance fails.

5. The apparatus according to claim 1, further comprising:
decoding means configured to decode a physical broadcast channel transmitted by the first or second communication base station having a higher hierarchical distance than the preset hierarchical distance and to retrieve a global identifier of this communication base station.

6. The apparatus according to claim 4, further comprising: control means configured to initiate a physical identifier detection procedure related to communication base stations, to decide on the hierarchical distance of a communication base station of which a physical identifier is detected, to trigger operation of the identifier obtaining means in dependency of a decision result, and to trigger operation of the synchronization means and the selection means.

7. An evolved Node B comprising an apparatus according to claim 1.

8. A method, comprising:
requesting a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

9. The method according to claim 8, further comprising:
tracing a common reference signal of the communication base station having the preset hierarchical distance; and
synchronizing a communication configuration with the communication base station having the preset hierarchical distance.

10. The method according to claim 8, further comprising:
detecting that the physical identifier of the communication base station having the preset hierarchical distance or the common reference signal of the communication base station having the preset hierarchical distance is not available; and
selecting a second communication base station having a higher hierarchical distance than the preset hierarchical distance and based on a signal strength at a signal receiving position, while ignoring the first communication base station.

11. The method according to claim 10, further comprising:
detecting that tracing a common reference signal of the communication base station having the preset hierarchical distance fails; and
synchronizing a communication configuration with the first or second communication base station.

12. The method according to claim 8, further comprising:
decoding a physical broadcast channel transmitted by the first or second communication base station having a higher hierarchical distance than the preset hierarchical distance; and
retrieving a global identifier of this communication base station.

13. The method according to claim 8, further comprising:
initiating a physical identifier detection procedure related to communication base stations; and
deciding on the hierarchical distance of a communication base station of which a physical identifier is detected,
wherein the initiating and deciding is performed prior to the requesting.

14. A computer program product comprising computer-executable components which perform, when the program is run on a computer:
requesting a physical identifier of a communication base station having a preset hierarchical distance to a communication core network from a first communication base station having a higher hierarchical distance than the preset hierarchical distance, based on a connection on one of an interface between a communication base station having a higher hierarchical distance than the preset hierarchical distance and the communication core network and an interface between two communication base stations both having a higher hierarchical distance than the preset hierarchical distance.

15. The computer program product according to claim 14, embodied as a computer-readable storage medium.
